(19) United States
(12) Patent Application Publication
(10) Pub. No.: US 2026/0044124 A1
(43) Pub. Date: Feb. 12, 2026

(54) METHOD FOR MONITORING MACHINE

(71) Applicant: UNITED MICROELECTRONICS CORP., Hsinchu (TW)

(72) Inventors: Yung-Yu YANG, Tainan City (TW); Wei-Chih LIAO, Taichung City (TW); Chih-Kuan CHANG, Tainan City (TW); Chung-Chih HUNG, Kaohsiung City (TW); Chen-Hui HUANG, Hsinchu City (TW)

(21) Appl. No.: 18/893,135

(22) Filed: Sep. 23, 2024

(30) Foreign Application Priority Data
Aug. 8, 2024 (TW) 113129739

(51) Int. Cl. G05B 13/02

(52) U.S. Cl. CPC G05B 13/021

(57) ABSTRACT

A method for monitoring a machine includes: manufacturing products by at least one machine, and the machine includes a sensor used to detect first data of a parameter of the products during manufacturing the products. The first data of the parameter are transmitted to a monitoring system by the machine. A final upper warning line and a final lower warning line are established by the monitoring system to determine whether the parameter is abnormal. The steps for establishing the final upper warning line and the final lower warning line include: using the monitoring system to calculate a plurality of change amounts in the first data between seconds, and selecting a minimum change amount among the change amounts corresponding to each of the products. The minimum change amounts form a minimum change amount set, and a minimum value is selected as a resolution among the minimum change amount set.

This application claims the benefit of Taiwan application Serial No. 113129739, filed Aug. 8, 2024, the subject matter of which is incorporated herein by reference.

### BACKGROUND OF THE INVENTION

### Field of the Invention

The invention relates in general to a method for monitoring, and more particularly to a method for monitoring a machine.

### Description of the Related Art

Generally speaking, a Fault Detection and Classification (FDC) chart is generated by statistical calculation using initial data of machine parameters, and then warning lines are established using appropriate statistical methods based on data type of the initial data. The statistical methods include, for example, the use of normal distribution curves and standard deviations. However, if the data in the FDC chart has no variation or is stable, it will be hard to use effective statistical methods to establish the warning lines.

### SUMMARY OF THE INVENTION

The invention is directed to a method for manufacturing a machine, which can establish reasonable warning lines, thereby improving the accuracy of machine monitoring.

According to an embodiment of the present invention, a method for monitoring a machine is provided. The method includes the following steps. A plurality of products are manufactured by at least one machine, and the machine includes a sensor. The sensor is used to detect a plurality of first data of a parameter of the products during their manufacturing. The first data of the parameter are transmitted to a monitoring system by the machine. A final upper warning line and a final lower warning line are established by the monitoring system to determine whether the parameter is abnormal. The steps for establishing the final upper warning line and the final lower warning line include the following steps. The monitoring system is used to calculate a plurality of change amounts in the first data between seconds, and a minimum change is selected among the change amounts corresponding to each of the products. The minimum change amounts of the products form a minimum change amount set, and a minimum value is selected as a resolution among the minimum change amount set. After the monitoring system collects the first data and removes the first data which are out of specification, the first data of maximum values in each of the days become a plurality of second data, and the first data of minimum values in each of the days become a plurality of third data. The monitoring system selects a maximum value data set of the second data and a minimum value data set of the third data in a time interval. An initial upper warning line and an initial lower warning line are calculated by the monitoring system, wherein the initial upper warning line represents a maximum value of the maximum value data set, and the initial lower warning line represents a minimum value of the minimum value data set. A shift value is calculated by the monitoring system, wherein the shift value represents the maximum value between 3 times the resolution and an interval variation. The interval variation represents 1/10 of the difference between the initial upper warning line and the initial lower warning line. The final upper warning line and The final lower warning line are calculated by the monitoring system, wherein the final upper warning line represents the initial upper warning line plus the shift value, and the final lower warning line represents the initial lower warning line minus the shift value.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a flowchart for obtaining a resolution of a parameter of a machine.

FIG. 2A shows a part of a flow chart of a method for establishing warning lines according to an embodiment of the present invention.

FIG. 2B shows another part of the flow chart that continues FIG. 2A.

FIG. 3 illustrates a method for monitoring a machine according to an embodiment of the present invention.

FIG. 4 illustrates a method for establishing warning lines according to an embodiment of the present invention.

FIG. 5 shows a simplified schematic diagram of a monitoring system according to an embodiment of the present invention.

FIG. 6A is a schematic diagram of the upper warning line and the lower warning line according to Embodiment A and Comparative Example A of the present invention.

FIG. 6B is a schematic diagram of the upper warning line and the lower warning line according to Embodiment B and Comparative Example B of the present invention.

### DETAILED DESCRIPTION OF THE INVENTION

The following is illustrated with some examples. It should be noted that the present invention does not show all possible embodiments, and other implementation aspects not proposed in the present invention may also be applicable. Furthermore, the size ratios in the drawings are not drawn to the same proportions as the actual product. Therefore, the description and drawings are only used to describe the embodiments and are not used to limit the scope of the present invention. In addition, the descriptions in the embodiments, such as detailed structures, material applications, etc., are only for illustration and do not limit the scope of the present invention. The structural details of the embodiments can be changed and modified according to the needs of the actual application process without departing from the spirit and scope of the present invention. The following description uses the same/similar symbols to indicate the same/similar components. It is understood that elements and features of one embodiment may be advantageously incorporated into another embodiment without further recitation.

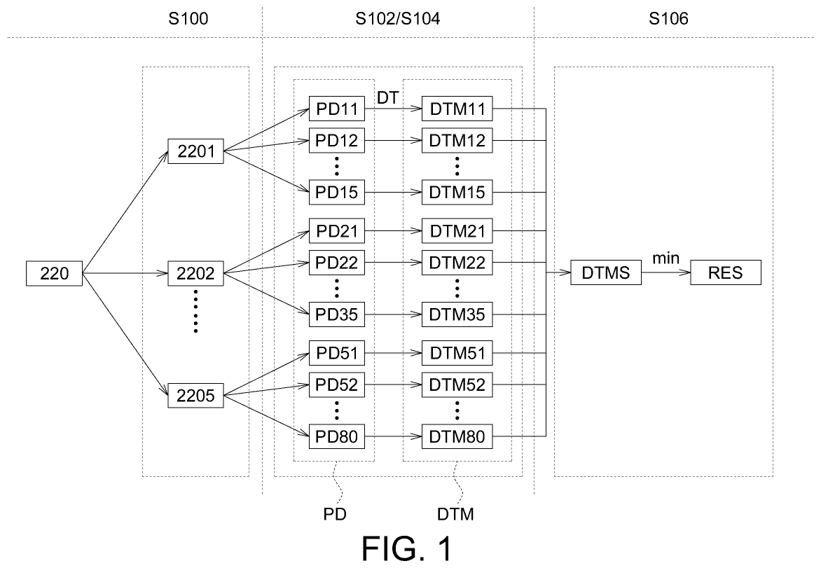

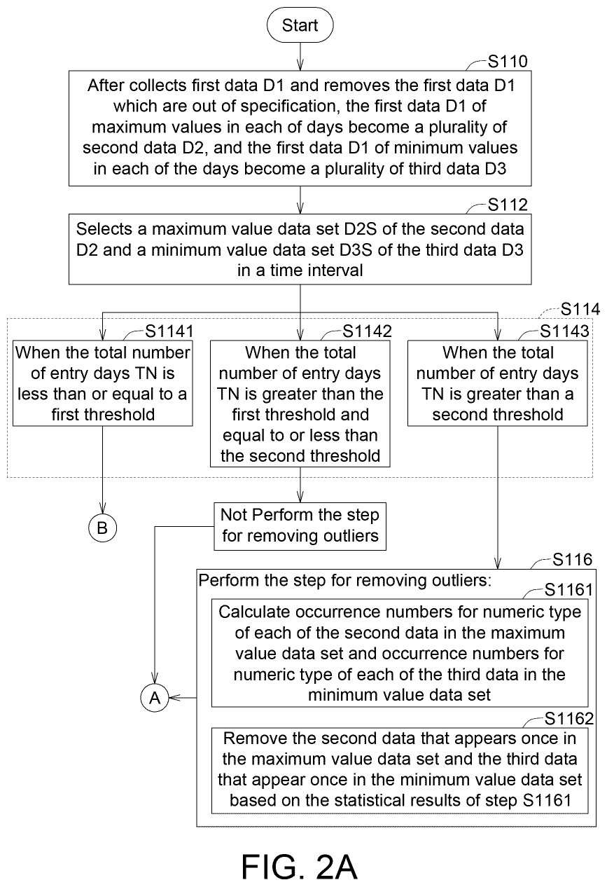

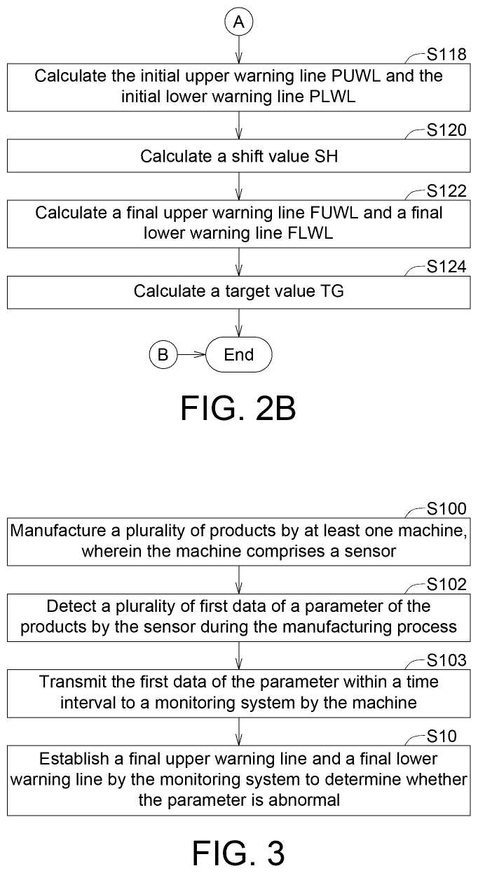

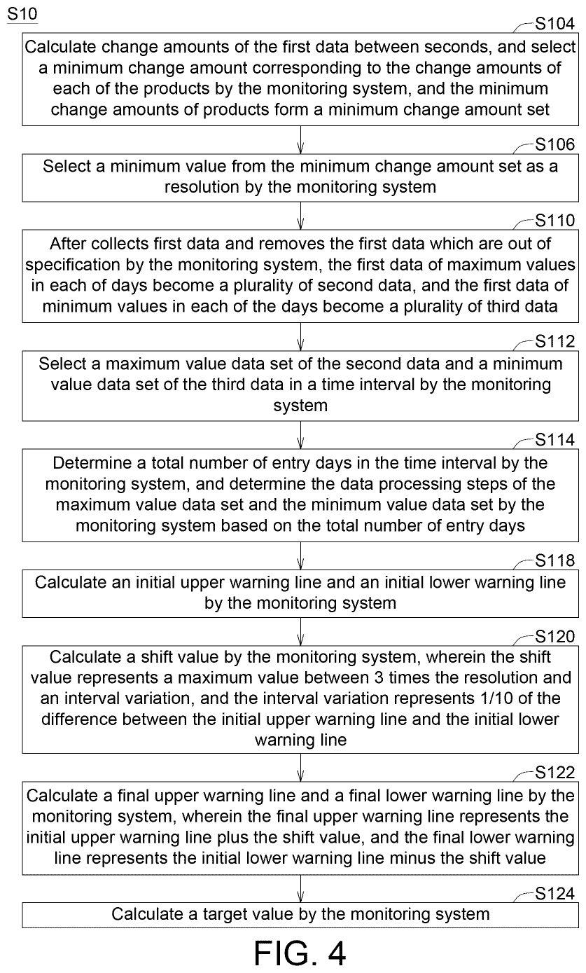

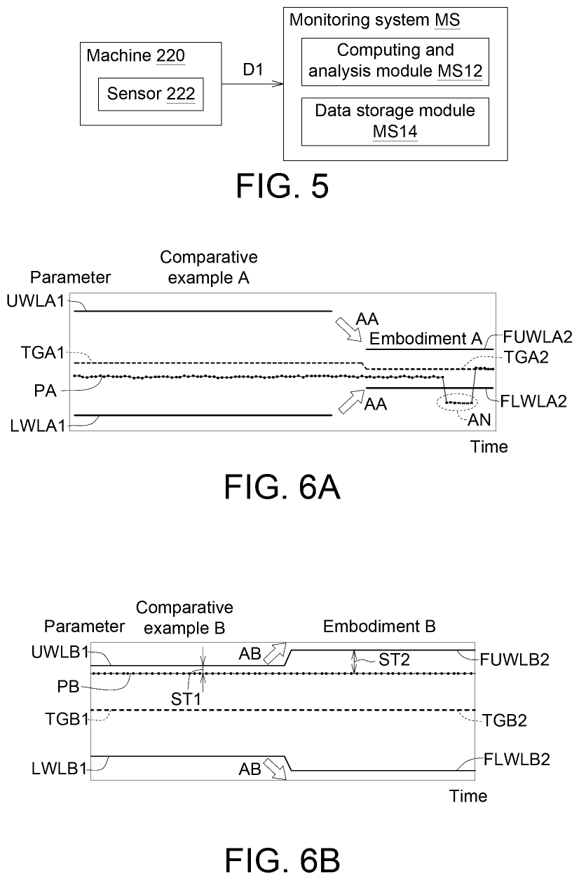

FIG. 1 illustrates the flowchart for obtaining a resolution RES of a parameter of a machine (including sequential steps S100 to S106). FIG. 2A illustrates a part of the flowchart of a method for establishing warning lines according to an embodiment of the present invention (including sequential steps S110 to S116). FIG. 2B shows another part of the flowchart that continues FIG. 2A (including sequential steps S118 to S124). FIG. 3 illustrates a method for monitoring a machine (including sequential steps S100 to S10) according to an embodiment of the present invention. FIG. 4 illustrates a method for establishing warning lines according to an embodiment of the present invention. FIG. 5 shows a simplified schematic diagram of a monitoring system MS according to an embodiment of the present invention.

Please refer to FIGS. 1 and 3. As shown in step S100, a plurality of products PD are manufactured by at least one machine 220. The number of machines 220 may be plural. For example, a plurality of machines 220 of the same process type manufacture a plurality of products PD, and each of the machines 220 can produce a plurality of products PD. The products PD are, for example, wafers or other suitable products. In one embodiment, the machine 220 may include machines 2201 to 2205 of the same process type. Each of the machines 2201 to 2205 can produce different quantities of products PD. For example, machine 2201 can form 5 products PD11, PD12 . . . . PD15 by 5 manufacturing processes; machine 2202 can form 15 products PD21, PD22 . . . . PD35 by 15 manufacturing processes; machine 2205 can form 30 products PD51, PD52 . . . . PD80 by 30 manufacturing processes. That is, each of the manufacturing processes forms a product PD. It should be understood that the numbers of machines 220 and products PD of the present invention are not limited thereto. Each of the machines 220 includes a plurality of sensors 222, and the sensors 222 can be used to detect various parameters (such as temperature, pressure or other parameters) of the machines 220 during manufacturing the products PD. The sensor 222 is, for example, a temperature sensor, a pressure sensor, a pressure sensor, a speed sensor or other suitable sensor.

Please refer to FIGS. 1 and 3. As shown in step S102, a sensor 222 detects a plurality of first data D1 of a parameter of the products PD during the manufacturing process (i.e., report values of the parameter of the products within a time interval). A parameter is, for example, the temperature, pressure, voltage, speed or other suitable parameter.

Please refer to FIG. 3. As shown in step S103, the machines 220 transmit the first data D1 of the parameter within a time interval to a monitoring system MS. As shown in FIG. 5, the monitoring system MS includes a computing and analysis module MS12 and a data storage module MS14. The data storage module MS14 can be coupled to the computing and analysis module MS12 to store and memorize required information. The computing and analysis module MS12 and the data storage module MS14 can be implemented by hardware circuits or software. For example, the computing and analysis module MS12 may be implemented by an integrated circuit or a processor. The data storage module MS14 can be implemented by a memory.

For example, the machines 220 transmit the first data D1 of the parameter detected by the sensor 222 to the monitoring system MS by wireless transmission or wired transmission (as shown in FIG. 5). When the products PD are wafers, the parameter is temperature, and the time interval is 100 seconds, in step S103, the monitoring system MS can obtain the temperature at the 1st second, the temperature at the 2nd second, the temperature at the 3rd second . . . and the temperature at the 100th second during the processes of manufacturing the wafers. Thereafter, as shown in step S10, a final upper warning line FUWL and a final lower warning line FLWL are established by the monitoring system MS to determine whether the parameter is abnormal. Step S10 includes steps S104 to S106 in FIG. 1 and steps S110 to S122 in FIGS. 2A to 2B, as shown in FIG. 4.

Please refer to FIGS. 1 and 4 at the same time. As shown in step S104, the monitoring system MS can calculate absolute values of differences between seconds (i.e., change amounts DT of the first data D1 between seconds), and select a minimum change amount DTM corresponding to the change amounts DT of each of the products PD, so the minimum change amounts DTM of multiple products PD form a minimum change amount set DTMS. When the products PD are wafers and the parameter is temperature, the monitoring system MS calculates in step S104 an absolute value of the difference in temperature between the first second and the second (2nd) second (that is, the change amounts DT1 of the first data D1), and the absolute value of the difference in temperature between the 2nd second and the third second (i.e., the change amounts DT2 of the first data D1). In other words, if the processing time of a product PD is 100 seconds, there are 99 absolute values of differences in temperature between the 1st second and the 100th second (that is, 99 change amounts DT1 to DT99 in the first data D1). The processing time for each of the products PD may be different. As shown in step S104 of FIG. 1, one product PD formed in each manufacturing process may correspond to one minimum change amount DTM. For example, the products PD11 to PD15, PD21 to PD35 and PD51 to PD80 can respectively correspond to the minimum change amount DTM11 to DTM15, DTM21 to DTM35 and DTM51 to DTM80. All of the minimum change amounts DTM11 to DTM15, DTM21 to DTM35 . . . . DTM51 to DTM80 form a minimum change amount set DTMS.

Please refer to FIGS. 1 and 4 at the same time. As shown in step S106, the monitoring system MS can select a minimum value min from the minimum change amount set DTMS as a resolution RES of the process type of the machines 220 by the computing and analysis module MS12. The resolution RES of the parameter of the machine 220 is stored in the data storage module MS14 of the monitoring system MS (as shown in FIG. 5).

The monitoring system MS can use initial data (for example, first data D1) of the parameters of the machines 220 to generate a FDC (Fault Detection and Classification) chart by statistical calculations, and then establish warning lines to detect whether the product is abnormal based on the FDC chart and the following Steps S110 to S124 as shown in FIGS. 2A to 2B. Establishing the warning lines may include establishing an upper warning line, a lower warning line and a target value. When a product exceeds the range between the upper warning line and the lower warning line, it means that the product is abnormal. In the present embodiment, the monitoring system MS can be used to establish a final upper warning line FUWL, a final lower warning line FLWL and a target value TG.

Please refer to FIGS. 2A and 4. As shown in step S110, after the monitoring system MS collects all of the first data D1 on the FDC chart of the parameter of the machines 220, and removes the first data D1 which are out of specification (OOS) by the computing and analysis module MS12, the first data D1 of maximum values in each of days become a plurality of second data D2 (established by the computing and analysis module MS12), and the first data D1 of minimum values in each of the days become a plurality of third data D3 (established by the computing and analysis module MS12). For example, when the parameter of the machines 220 is temperature, the computing and analysis module MS12 of the monitoring system MS collects the maximum temperatures in each of the days and the minimum temperatures in each of the days after the first data D1 which are out of specification (OOS) are removed, and then the maximum temperatures in each of the days become a plurality of second data D2, and the minimum temperatures in each of the days becomes a plurality of third data D3.

Please refer to FIGS. 2A and 4. As shown in step S112, a maximum value data set D2S of the second data D2 and a minimum value data set D3S of the third data D3 in a time interval (for example, the closest 180 days) are selected by the monitoring system MS (for example, by the computing and analysis module MS12). For example, when the parameter of the machines 220 is temperature, the highest temperatures (i.e., the second data D2) in each of the days in the above-mentioned time interval (for example, 180 days) are selected to form a maximum value data set D2S, and the lowest temperatures (i.e., the third data D3) in each of the days in the above-mentioned time interval (for example, 180 days) are selected to form a minimum value data set D3S by the computing and analysis module MS12 of the monitoring system MS.

Please refer to FIGS. 2A and 4. As shown in step S114, a total number of entry days TN in the time interval (that is, the total number of days having both of the second data D2 and the third data D3) are determined by the monitoring system MS (for example, by the computing and analysis module MS12), and the data processing steps of the maximum value data set D2S and the minimum value data set D3S are determined by the monitoring system MS (for example, by the computing and analysis module MS12) based on the total number of entry days TN. That is, one of steps S1141 to S1142 (as shown in FIG. 2A) to be performed is determined by the monitoring system MS (for example, by the computing and analysis module MS12).

Please refer to FIGS. 2A to 2B. As shown in step S1141, when the total number of entry days TN is less than or equal to a first threshold (for example, 5), the monitoring system MS does not calculate the warning lines and directly ends the process for calculating the warning lines. A contact point B in FIG. 2A is connected to a contact point B in FIG. 2B.

Please refer to FIGS. 2A to 2B. As shown in step S1142, when the total number of entry days TN is greater than the first threshold (for example, 5) and equal to or less than the second threshold (for example, 30), no step for removing outlier is performed, and step S118 of calculating an initial upper warning line PUWL and an initial lower warning line PLWL is directly performed. A contact point A in FIG. 2A is connected to a contact point A in FIG. 2B.

Please refer to FIG. 2A. As shown in step S1143, when the total number of entry days TN is greater than a second threshold (for example, 30), the monitoring system MS can perform the step S116 for removing the outliers by the computing and analysis module MS12. The step S116 for removing the outliers may include the following steps S1161 and S1162.

As shown in step S1161, occurrence numbers for numeric type of each of the second data D2 in the maximum value data set D2S and occurrence numbers for numeric type of each of the third data D3 in the minimum value data set D3S are calculated by the computing and analysis module MS12 of the monitoring system MS.

As shown in step S1162, the computing and analysis module MS12 of the monitoring system MS can remove the second data D2 that appears once in the maximum value data set D2S and the third data D3 that appear once in the minimum value data set D3S based on the statistical results of step S1161. Thereafter, the step S118 for calculating the initial upper warning line PUWL and the initial lower warning line PLWL can be performed by the computing and analysis module MS12 of the monitoring system MS.

Please refer to FIGS. 2B and 4. As shown in step S118, the initial upper warning line PUWL and the initial lower warning line PLWL are calculated by the monitoring system MS (for example, by the computing and analysis module MS12), wherein the initial upper warning line PUWL represents the maximum value of the maximum value data set D2S, and the initial lower warning line PLWL represents the minimum value of the minimum value data set D3S.

Please refer to FIGS. 2B and 4. As shown in step S120, a shift value SH is calculated by the monitoring system MS (for example, by the computing and analysis module MS12), wherein the shift value SH represents a maximum value (i.e. MAX) between 3 times the resolution RES (as shown in step S106) and an interval variation V1 (as shown in the following Formula 1). The interval variation V1 represents 1/10 of the difference between the initial upper warning line PUWL and the initial lower warning line PLWL (as shown in the following Formula 2).

$$SH = MAX ( 3 RES , V 1 ) \qquad Formula 1$$

$$V 1 = ( PUWL - PLWL ) / 10 \qquad Formula 2$$

Please refer to FIGS. 2B and 4. As shown in step S122, the final upper warning line FUWL and the final lower warning line FLWL are calculated by the monitoring system MS (for example, by the computing and analysis module MS12), wherein the final upper warning line FUWL represents the initial upper warning line PUWL plus the shift value SH (as shown in the following Formula 3), and the final lower warning line FLWL represents the initial lower warning line PLWL minus the shift value SH (as shown in the following Formula 4).

$$FUWL = PUWL + SH \qquad Formula 3$$

$$FLWL = PLWL - SH \qquad Formula 4$$

Please refer to FIGS. 2B and 4. As shown in step S124, the target value TG is calculated by the monitoring system MS (for example, by the computing and analysis module MS12), wherein the target value TG represents the sum of the final upper warning line FUWL and the final lower warning line FLWL divided by 2, as shown in the following Formula 5.

$$TG = ( FUWL + FLWL ) / 2 \qquad Formula 5$$

FIG. 6A is a schematic diagram of the upper warning line and the lower warning line according to Embodiment A and Comparative example A of the present invention. FIG. 6B is a schematic diagram of the upper warning line and the lower warning line according to Embodiment B and Comparative Example B of the present invention. In FIGS. 6A-6B, the X-axis represents time, and the unit can be seconds, minutes, hours, days, etc.; the Y-axis represents a parameter, and the unit is determined according to the parameter.

Please refer to FIG. 6A. In Comparative Example A, an upper warning line UWLA1, a lower warning line LWLA1 and a target value TGA1 for a parameter PA are established according to general statistical methods (for example, using the normal distribution curve and standard deviations). In Embodiment A, an upper warning line FUWLA2, a lower warning line FLWLA2 and the target value TGA2 for the parameter A are established according to the method of the present invention. It can be seen from the results that Embodiment A can establish reasonable warning lines, which appropriately reduce the range of the warning lines (as shown by arrow AA), improve defense capabilities, and detect the abnormality AN of the parameter PA early.

Please refer to FIG. 6B. In Comparative Example B, an upper warning line UWLB1, a lower warning line LWLB1 and a target value TGB1 for a parameter PB are established according to general statistical methods (for example, using the normal distribution curve and standard deviations). In Embodiment B, an upper warning line FUWLB2, a lower warning line FLWLB2 and a target value TGB2 for the parameter PB are established according to the method of the present invention. It can be seen from the results that during the process of monitoring the parameter PB, a distance ST1 between the parameter PB and the upper warning line UWLB1 is smaller than a distance ST2 between the parameter PB and the upper warning line FUWLB2. Therefore, Embodiment B can establish reasonable warning lines, moderately relax the control range (as shown by arrow AB), and reduce the occurrence rate of false alarm.

According to an embodiment, the present invention provides a method for monitoring a machine. The method for monitoring a machine of the present invention can establish reasonable final upper warning lines and final lower warning lines for different parameters. For example, when the data in the FDC chart has no variation or the data is stable, reasonable warning lines (the final upper warning line and the final lower warning line) can still be established, so that the abnormal parameter can be detected early, or the occurrence rate of the false alarm can be reduced, so the accuracy for monitoring the machine can be improved.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for monitoring a machine, comprising:
manufacturing a plurality of products by at least one machine, wherein the at least one machine comprises a sensor;
detecting a plurality of first data of a parameter of the products by the sensor during manufacturing the products;
transmitting the first data of the parameter to a monitoring system by the machine; and
establishing a final upper warning line and a final lower warning line by the monitoring system to determine whether the parameter is abnormal, wherein the steps for establishing the final upper warning line and the final lower warning line comprises the following steps:
calculating a plurality of change amounts in the first data between seconds, and selecting a minimum change amount among the change amounts corresponding to each of the products by the monitoring system, the minimum change amounts of the products forming a minimum change amount set, and a minimum value is selected as a resolution among the minimum change amount set;
after collecting the first data and removing the first data which are out of specification by the monitoring system, the first data of maximum values in each of days becoming a plurality of second data, and the first data of minimum values in each of the days becoming a plurality of third data;
selecting a maximum value data set of the second data and a minimum value data set of the third data in a time interval by the monitoring system;
calculating an initial upper warning line and an initial lower warning line by the monitoring system, wherein the initial upper warning line represents a maximum value of the maximum value data set, and the initial lower warning line represents a minimum value of the minimum value data set
calculating a shift value by the monitoring system, wherein the shift value represents a maximum value between 3 times the resolution and an interval variation, the interval variation represents 1/10 of a difference between the initial upper warning line and the initial lower warning line; and
calculating the final upper warning line and the final lower warning line by the monitoring system, wherein the final upper warning line represents the initial upper warning line plus the shift value, and the final lower warning line represents the initial lower warning line minus the shift value.

2. The method according to claim 1, further comprising:
determining a total number of entry days in the time interval and determining one of following steps to be performed based on the total number of entry days by the monitoring system, wherein the total number of entry days represents a number of days having the second data and the third data:
when the total number of entry days is less than or equal to a first threshold, the monitoring system does not calculate the final upper warning line and the final lower warning line;
when the total number of entry days is greater than the first threshold and equal to or less than a second threshold, the monitoring system performs the step of calculating the initial upper warning line and the initial lower warning line; and
when the total number of entry days is greater than the second threshold, the monitoring system performs steps of removing outliers.

3. The method according to claim 2, wherein the steps of removing outliers comprises:
calculating occurrence numbers for numeric type of each of the second data in the maximum value data set and occurrence numbers for numeric type of each of the third data in the minimum value data set by the monitoring system; and
removing the second data that appears once in the maximum value data set and the third data that appears once in the minimum value data set by the monitoring system.

4. The method according to claim 3, wherein, after the steps of removing outliers are finished, the steps of calculating the initial upper warning line and the initial lower warning line are performed.

5. The method according to claim 2, wherein the first threshold is 5, and the second threshold is 30.

6. The method according to claim 1, further comprising:
calculating a target value by the monitoring system, wherein the target value represents a sum of the final upper warning line and the final lower warning line divided by 2.

7. The method according to claim 1, wherein a number of the at least one machine is plural.

8. The method according to claim 1, wherein the change amounts represent absolute values of differences between seconds for the parameter of the products.

9. The method according to claim 1, wherein the time interval is 180 days.

10. The method according to claim 1, wherein the monitoring system comprises a computing and analysis module and a data storage module; after the resolution is calculated by the computing and analysis module, the resolution is stored in the data storage module.
